(19) United States
(12) Patent Application Publication
(10) Pub. No.: US 2022/0271322 A1
(43) Pub. Date: Aug. 25, 2022

(54) FUEL CELL SYSTEM AND VENTILATION METHOD

(71) Applicant: HONDA MOTOR CO., LTD., TOKYO (JP)

(72) Inventors: Hideharu NAITO, WAKO-SHI (JP); Takashi TAKURA, WAKO-SHI (JP)

(21) Appl. No.: 17/675,580

(22) Filed: Feb. 18, 2022

(30) Foreign Application Priority Data
Feb. 24, 2021 (JP) 2021-027481

(51) Int. Cl. H01M 8/2484

(52) U.S. Cl. CPC H01M 8/2484; H01M 2250/20

(57) ABSTRACT

A fuel cell system includes a stack case in which a fuel cell stack is housed, a ventilation device that is provided in the stack case and takes in outside air into the stack case, and a flow guide portion that is provided for the ventilation device and in which a plurality of slit-shaped air introduction passages that are inclined upward from the outside to the inside of the stack case are arranged in parallel, wherein an upper end of an inlet of each of the air introduction passages is located below a lower end of an outlet of each of the air introduction passages.

### CROSS-REFERENCE TO RELATED APPLICATIONS

This application is based upon and claims the benefit of priority from Japanese Patent Application No. 2021-027481 filed on Feb. 24, 2021, the contents of which are incorporated herein by reference.

### BACKGROUND OF THE INVENTION

### Field of the Invention

The present invention relates to a fuel cell system and a ventilation method.

### Description of the Related Art

A fuel cell system has a fuel cell stack and a stack case. The stack case covers the fuel cell stack. The stack case has a ventilation opening on a wall surface for discharging to the outside hydrogen gas leaked from the fuel cell stack. The ventilation opening has a filter and a ventilation cover. The filter removes fine dust contained in the outside air. The ventilation cover protects the filter from larger foreign objects such as gravel or water droplets.

For example, WO 2015/052892 A1 discloses a ventilation cover having a louver. The louver has a plurality of inclined blades provided at an opening portion. Thus, the ventilation cover prevents the entry of long linear objects such as thin metal threads.

### SUMMARY OF THE INVENTION

It is an object of the present invention to provide a fuel cell system and a ventilation method having excellent ventilation performance concerning hydrogen gas staying in a stack case.

In one aspect of the following disclosure, there is provided a fuel cell system comprising: a fuel cell stack in which a plurality of power generating cells are stacked; a stack case that houses the fuel cell stack; a ventilation device that is provided for the stack case and takes outside air into the stack case; and a flow guide portion that is provided for the ventilation device and has a plurality of slit-shaped air introduction passages that are inclined upward from the outer side to the inner side of the stack case and are arranged in parallel with each other, wherein the upper end of the inlet of each of the air introduction passages is located below the lower end of the outlet of each of the air introduction passages.

Another aspect is a method for ventilating a fuel cell system mounted in a vehicle, comprising a fuel cell stack in which a plurality of power generating cells are stacked, a stack case that houses the fuel cell stack, and a ventilation device that is provided for the stack case and takes outside air into the stack case, wherein the ventilation device includes a flow guide portion in which a plurality of slit-shaped air introduction passages are inclined upward from the outer side to the inside of the stack case and are arranged in parallel with each other, and the ventilation device is disposed toward the front of the vehicle, whereby an upward air flow is generated inside the stack case by utilizing wind pressure of running wind generated by driving of the vehicle and diffusion of hydrogen gas staying in an upper part of the stack case is enhanced.

According to the fuel cell system and the ventilation method of the above aspect, the ventilation performance for the hydrogen gas staying in the stack case is improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a fuel cell vehicle equipped with a fuel cell system according to a first embodiment;

FIG. 2 is a front view of a first ventilation portion of the fuel cell system of FIG. 1;

FIG. 3A is a cross-sectional view taken along line IIIA-IIIA of FIG. 2, and FIG. 3B is an enlarged cross-sectional view inside the dashed line of FIG. 3A;

FIG. 4 is a perspective view of a second ventilation portion of the fuel cell system of FIG. 1;

FIG. 5 illustrates the operation of the first ventilation portion of FIG. 2;

FIG. 6A is a perspective view of a first ventilation portion according to the second embodiment, and FIG. 6B is a perspective view of a second ventilation portion according to the second embodiment;

FIG. 7 is a cross-sectional view of the second ventilation portion of FIG. 6B.

### DESCRIPTION OF THE INVENTION

Hereinafter, preferred embodiments of the fuel cell system according to the present invention will be described in detail with reference to the accompanying drawings. In the following description, “left”, “right”, “front”, “rear”, “down” and “up” represent the left, right, front, rear, downward and upward directions of a user seated in the driver's seat of the vehicle. Further, the vehicle width direction is synonymous with the left-right direction, the vehicle length direction with the front-back direction or the traveling direction, and the vehicle height direction with the up-down direction.

### First Embodiment

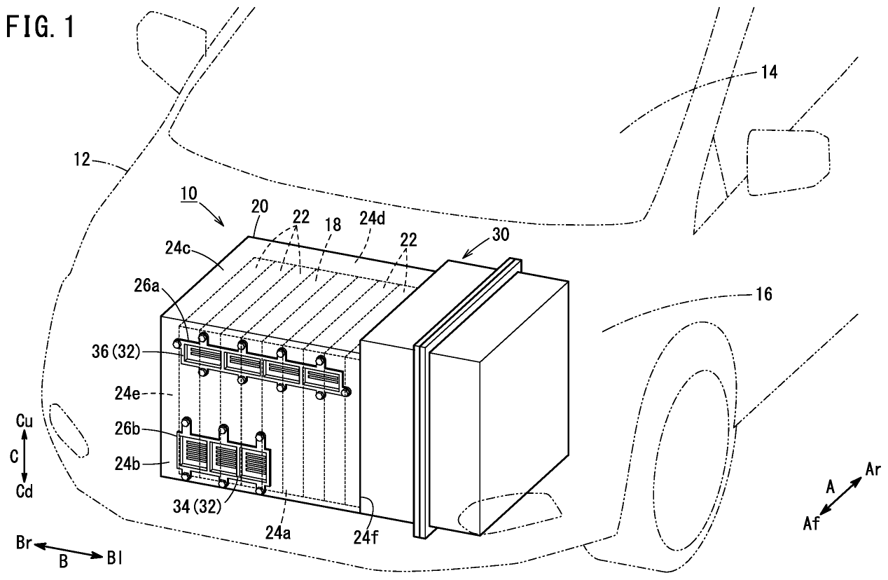

As shown in FIG. 1, a fuel cell system 10 according to the present embodiment is mounted in a vehicle 12 (fuel cell vehicle). The fuel cell system 10 supplies the vehicle 12 with electric power required for driving the vehicle 12. The vehicle 12 has a front room 16 in the front of the vehicle 12. The front room 16 is separated from a passenger compartment 14 by a dashboard (not shown). A stack case 20 housing the fuel cell stack 18 is disposed in the front room 16.

The fuel cell stack 18 generates electric power based on the electrochemical reaction of fuel gas and oxygen-containing gas. The fuel gas is supplied from a fuel gas supply device (not shown). The oxygen-containing gas is supplied from an oxygen-containing gas supply device (not shown). The fuel cell stack 18 supplies electric power generated by power generation to a driving motor or a battery (not shown) provided in the front room 16.

The fuel cell stack 18 includes a plurality of power generating cells 22. The plurality of power generating cells 22 are stacked in the vehicle width direction. The stack case 20 accommodates the fuel cell stack 18 being in this state. The stack case 20 is formed in a rectangular parallelepiped box shape and has a bottom wall portion 24a, a front wall portion 24b, an upper wall portion 24c, a rear wall portion 24d, a right side portion 24e, and a left side portion 24f. The stack case 20 has front openings 26a and 26b in the front wall portion 24b.

The power generating cell 22 has a first terminal plate and a first insulating plate (not shown) at the right end in the stacking direction (vehicle width direction Br). The first terminal plate and the first insulating plate are arranged in this order toward the outside. The stack case 20 also houses the first terminal plate and the first insulating plate. The stack case 20 has a first end plate (not shown) attached to the right side portion 24e.

The power generating cell 22 has a second terminal plate and a second insulating plate (not shown) at the left end in the stacking direction. The second terminal plate and the second insulating plate are arranged in this order toward the outside. The stack case 20 houses therein the second terminal plate and the second insulating plate. An auxiliary machine case 30 is attached to the left side portion 24f of the stack case 20. The auxiliary machine case 30 also serves as a second end plate for applying a fastening load in the stacking direction to the stack of the power generating cells 22.

The front wall portion 24b has the front openings 26a and 26b at two upper and lower positions. Each of the front openings 26a, 26b has a ventilation device 32. The ventilation device 32 has a first ventilation portion 34 and a second ventilation portion 36. The first ventilation portion 34 is provided in the lower front opening 26b. The second ventilation portion 36 is provided in the upper front opening 26a.

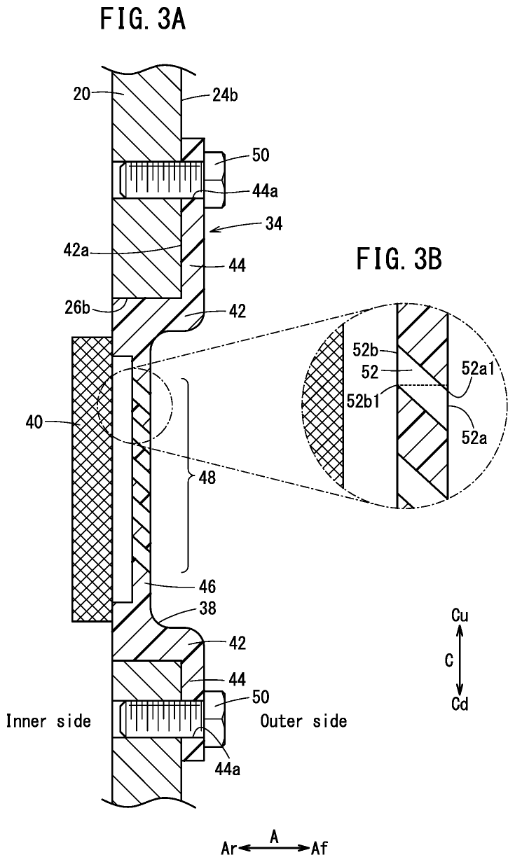

As shown in FIG. 3A, the first ventilation portion 34 includes a main body portion 38 and a filter 40. The filter 40 is disposed at the back side of the main body portion 38 (inner side of the stack case 20).

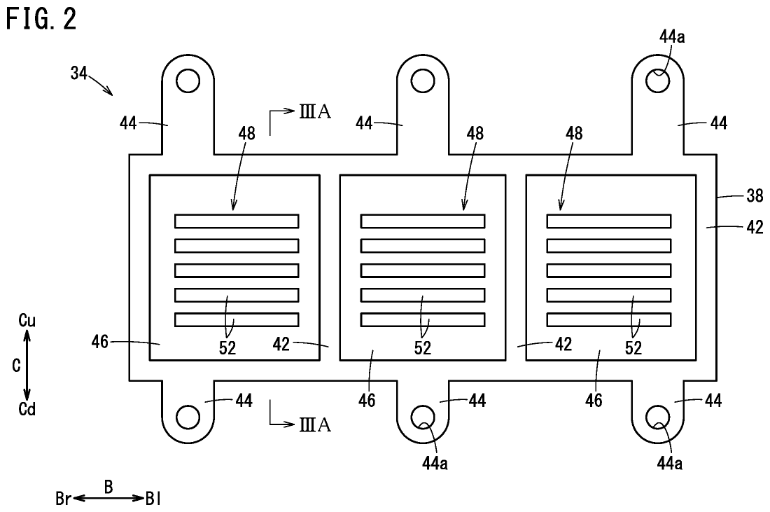

As shown in FIG. 2, the main body portion 38 has a rectangular plate shape when viewed from the front. The main body portion 38 has a frame portion 42, a fixing portion 44, a concave portion 46, and a flow guide portion 48. The frame portion 42 is disposed along a peripheral edge portion of the main body portion 38. The frame portion 42 protrudes further forward out of the paper surface of FIG. 2 than the concave portion 46 does. As shown in FIG. 3A, the frame portion 42 has an inwardly facing flat bottom portion 42a. The bottom portion 42a abuts against the front wall portion 24b of the stack case 20. Another part of the frame portion 42 has a reinforcing portion crossing the concave portion 46. In this embodiment, the frame portion 42 divides the concave portion 46. It should be noted that the frame portion 42 does not have to divide the concave portion 46. The frame portion 42 may be formed by a plurality of separated protrusions.

The frame portion 42 has a plurality of fixing portions 44 protruding outward. The fixing portion 44 has a through hole 44a through which a fixing bolt 50 (see FIG. 3A) is inserted. The fixing portion 44 fixes the first ventilation portion 34 to the stack case 20.

The concave portion 46 is concave toward the back side of the paper surface of FIG. 2 with respect to the frame portion 42. The concave portion 46 fits into the front opening 26b as shown in FIG. 3A to close the front opening 26b. As shown in FIG. 2, the concave portion 46 is separated into three portions by the frame portion 42. The separated concave portion 46 has the flow guide portion 48. In the first ventilation portion 34, the flow guide portion 48 is provided in each of the divided concave portions 46.

The flow guide portion 48 has a plurality of air introduction passages 52. Each air introduction passages 52 has a rectangular, slit shape in plan view. The air introduction passage 52 is elongated in the vehicle width direction. The length of the air introduction passage 52 in the vehicle width direction is longer than the thickness (dimension in the stacking direction) of the power generating cell 22. The air introduction passages 52 are arranged on a side surface of the plurality of power generating cells 22 with the filter 40 interposed therebetween. The flow guide portion 48 has a plurality of air introduction passages 52 (five in the case of the present embodiment) having a constant width. In the flow guide portion 48, the air introduction passages 52 are arranged at regular intervals in the up-down direction. The flow guide portion 48 has a rectangular shape in a front view.

As shown in FIG. 3B, the air introduction passages 52 pass through the concave portion 46 in the thickness direction. An outlet 52b (inner end portion) of the air introduction passage 52 is located at a position higher than an inlet 52a (outer end portion) of the air introduction passage 52, and the air introduction passage 52 is inclined so as to be inclined upward toward the inner side. Thus, the air introduction passage 52 generates an upward flow in the outside air passing through the air introduction passage 52. The air introduction passages 52, which are inclined in this manner, are arranged in parallel with each other in the flow guide portion 48.

An upper end 52a1 of the inlet 52a is formed at a position lower than a lower end 52b1 of the outlet 52b. Therefore, when viewed from the front side (Af side) perpendicular to the main body portion 38, the outlet 52b of the air introduction passage 52 is hidden above the inlet 52a. Therefore, the filter 40 at the back side of the air introduction passages 52 cannot be visually recognized in the front view. As a result, the air introduction passages 52 protect the filter 40 from foreign matters (small stones and water droplets) carried by the running wind.

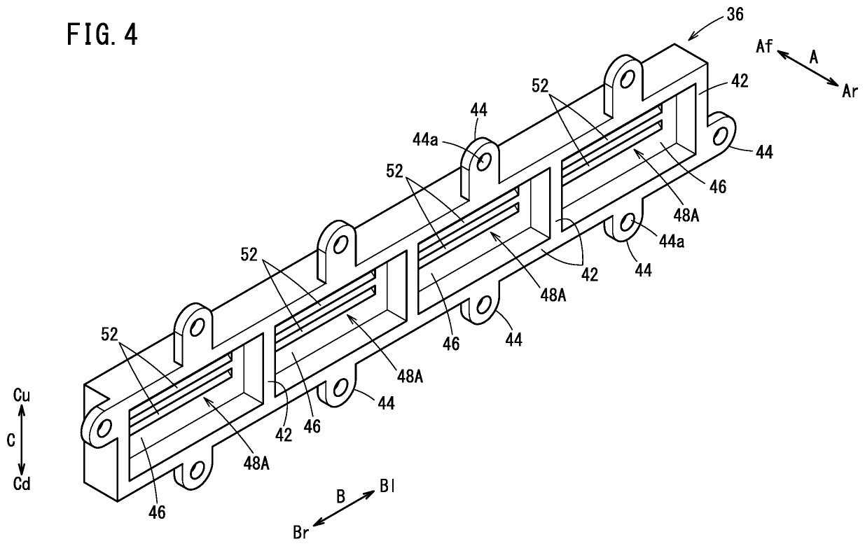

As shown in FIG. 1, the second ventilation portion 36 extends in the width direction (B direction) of the stack case 20. The second ventilation portion 56 has a shape wider in the width direction than the first ventilation portion 34. As shown in FIG. 4, the second ventilation portion 36 has a flow guide portion 48A. The flow guide portion 48A is disposed in the concave portion 46 surrounded by the frame portion 42 similar to the flow guide portion 48 of the first ventilation portion 34. The flow guide portion 48A faces most of the stacked power generating cells 22 with the filter 40 in between. Each of the flow guide portions 48A is the same as the flow guide portion 48 of the first ventilation portion 34 except that the number of air introduction passages 52 is reduced.

The fuel cell system 10 of this embodiment is configured as described above, and its operation will be described below.

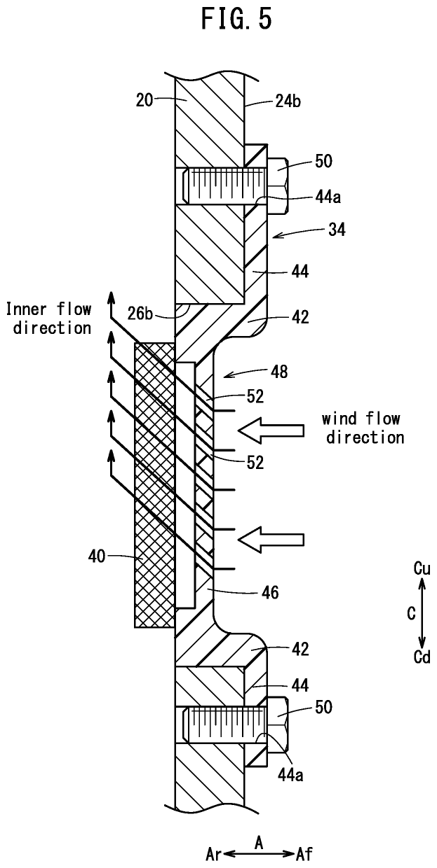

As the vehicle 12 travels, the running wind hits the front of the stack case 20. As shown in FIG. 5, the running wind strikes the flow guide portion 48 of the first ventilation portion 34 from the direction indicated by the hollow arrows. The running wind flows into the air introduction passages 52 in a state where the wind pressure is exerted on the air introduction passages 52. The plurality of air introduction passages 52 deflect the outside air upward. The outside air is deflected upward by the flow guide portion 48 and flows into the stack case 20 through the filter 40. The deflected outside air generates an upward air flow inside the stack case 20.

The second ventilation portion 36 functions in the same manner as the first ventilation portion 34. The outside air flows into the flow guide portion 48A in a state where the wind pressure of the running wind is exerted on the flow guide portion 48A. The air introduction passages 52 deflects the outside air so as to be directed upward in the flow guide portion 48A.

Since the specific gravity of the hydrogen gas leaked from the power generating cell 22 is small, the hydrogen gas tends to stay in an upper portion of the stack case 20. The ventilation device 32 of the present embodiment generates a flow directed upward of the stack case 20 by utilizing the momentum of the running wind. This flow efficiently diffuses the hydrogen gas staying in the upper portion of the stack case 20.

Further, the first ventilation portion 34 and the second ventilation portion 36 of the ventilation device 32 of the present embodiment have the flow guide portions 48 and 48A so as to face the plurality of power generating cells 22 arranged in the stacking direction. The flow guide portions 48 and 48A guide the outside air to the plurality of power generating cells 22 and rapidly dilute the hydrogen gas leaked from the power generating cells 22.

As shown in FIG. 1, the second ventilation portion 36 extends in a wider range in the vehicle width direction than the first ventilation portion 34. The second ventilation portion 36 disposed on an upper portion of the stack case 20 further improves the ventilation performance for the light hydrogen gas in the stack case 20.

The fuel cell system 10 of the present embodiment and the ventilation method thereof have the following effects.

The fuel cell system 10 of the present embodiment includes the fuel cell stack 18 in which a plurality of power generating cells 22 are stacked, and the stack case 20 in which the fuel cell stack 18 is housed. The stack case 20 has the ventilation device 32 that takes the outside air into the inside of the stack case 20. The ventilation device 32 has the flow guide portions 48, 48A. The air introduction passages 52 of the flow guide portions 48, 48A that are arranged in parallel with each other are inclined upward from the outer side of the stack case 20 toward the inner side of the stack case 20. The upper end 52a1 of the inlet 52a of the air introduction passage 52 is located below the lower end 52b1 of the outlet 52b of the air introduction passage 52.

The fuel cell system 10 having the above-described configuration, using the flow guide portions 48, 48A, generates an upward air flow inside the stack case 20, thereby improving the ventilation performance for the hydrogen gas inside the stack case 20. Further, the upper end 52a1 of the inlet 52a of the air introduction passage 52 is located below the lower end 52b1 of the outlet 52b of the air introduction passage 52, whereby the flow guide portions 48, 48A protect the filter 40 from foreign matter and water droplets.

In the fuel cell system 10 described above, the flow guide portions 48, 48A includes a plurality of air introduction passages 52 that have the same width in the horizontal direction. The flow guide portions 48, 48A are formed in a rectangular shape as viewed from the front. According to this configuration, it is possible to efficiently generate an upward air flow inside the stack case 20, whereby the ventilation performance inside the stack case 20 is improved.

In the fuel cell system 10 described above, the stack case 20 is mounted in the vehicle 12. The ventilation device 32 is provided in the front of the vehicle 12 on which the stack case 20 is mounted. Since the fuel cell system 10 can enhance an air flow inside the stack case 20 by utilizing the momentum of the running wind flowing from the front side of the vehicle 12, the ventilation performance is further improved.

In the fuel cell system 10 described above, the ventilation device 32 may be disposed so as to face the side portion with respect to the stacking direction of the power generating cells 22. The fuel cell system 10 can apply air passing through a ventilation device 32 to a plurality of power generating cells 22, and can quickly dilute the hydrogen gas flowing out from the power generating cells 22.

In the fuel cell system 10, the ventilation device 32 has a first ventilation portion 34 provided on a lower portion of the front wall portion 24b of the stack case 20 and the second ventilation portion 36 provided on the upper portion of the front wall portion 24b of the stack case 20.

In the fuel cell system 10 described above, the second ventilation portion 36 may be formed extending over the entire area in the stacking direction of the fuel cell stack 18. The fuel cell system 10 can supply an upward air flow to the plurality of power generating cells 22, and can improve the ventilation performance of the stack case 20.

In the fuel cell system 10 described above, the ventilation device 32 has the frame portion 42 that contacts and is fixed to the surface of the stack case 20, and the concave portion 46 that is concave further inward than the surface of the frame portion 42, and the flow guide portions 48, 48A may be provided in the concave portion 46.

Disclosed is a ventilation method for a fuel cell system (10) mounted on a vehicle (12), which comprises a fuel cell stack (18) in which a plurality of power generating cells (22) are stacked, a stack case (20) in which the fuel cell stack (18) is housed, and a ventilation device (32) which is provided in the stack case (20) and takes in outside air into the stack case (20), wherein the ventilation device (32) has flow guide portions (48, 48A) in which a plurality of slit-shaped air introduction passages (52) which incline upward from the outside to the inside of the stack case (20) are arranged in parallel, and the ventilation device (32) is arranged in front of the vehicle (12), whereby an upward air flow is generated inside the stack case (20) by utilizing the wind pressure of running wind generated by the running of the vehicle (12) to enhance the diffusion of hydrogen gas remaining in the upper part of the stack case (20).

In the above-described ventilation method, the ventilation device 32 may be disposed on the side of the power generating cells 22 in the stacking direction, so that the air flow by the running wind of the vehicle 12 may be applied to the plurality of power generating cells 22.

### Second Embodiment

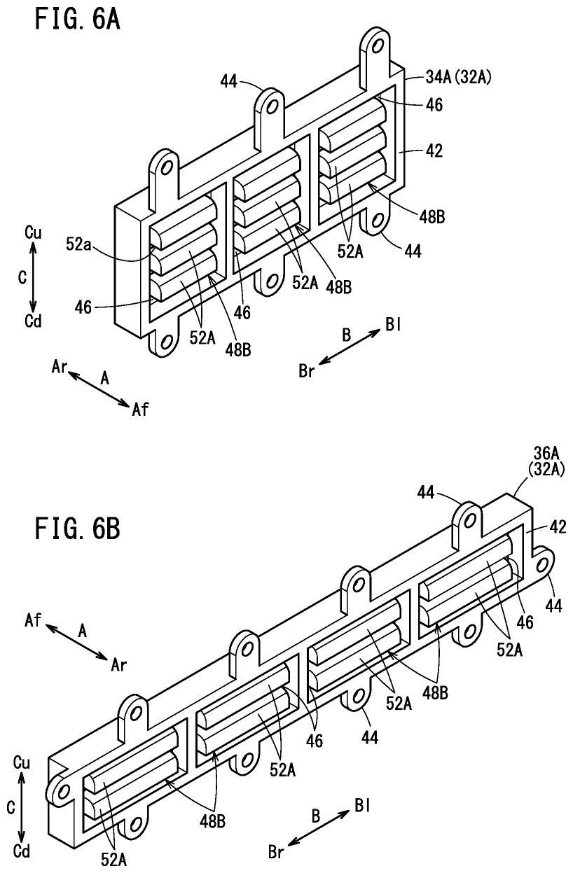

The present embodiment is different from the fuel cell system 10 of the first embodiment in the configuration of the ventilation device 32A. As shown in FIG. 6A, the first ventilation portion 34A of the ventilation device 32A includes a frame portion 42, a fixing portion 44, a concave portion 46, and a flow guide portion 48B. As shown in FIG. 6B, the second ventilation portion 36A includes a frame portion 42, a fixing portion 44, a concave portion 46, and a flow guide portion 48B similar to the first ventilation portion 34A. In the first ventilation portion 34A and the second ventilation portion 36A, the frame portion 42, the fixing portion 44, and the concave portion 46 are the same as those shown in FIGS. 2 to 4.

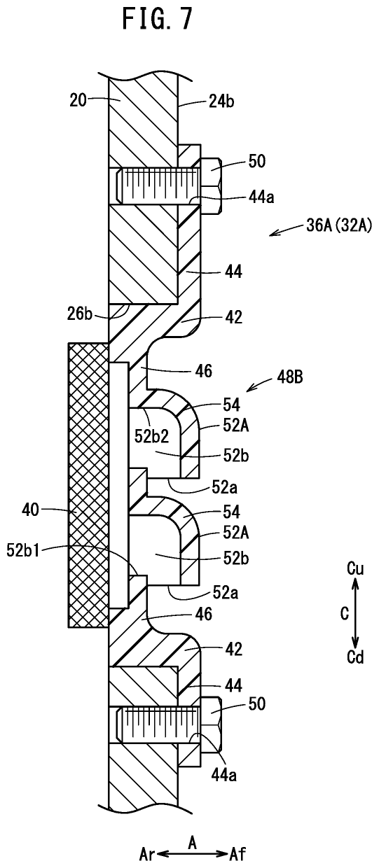

As shown in FIG. 7, the flow guide portion 48B has air introduction passages 52A that is convex upward. The air introduction path 52A is provided with a vane plate 54 that is convex upward. The vane plate 54 protrudes from the upper end 52b2 of the outlet 52b of the air introduction passage 52A to the outside of the stack case 20, curves downward, and covers the entire area of the outlet 52b. The lower end portion of the vane plate 54 extends downward. The lower end of the vane plate 54 serves as an inlet 52a of the air introduction passage 52A. The inlet 52a opens downward. The inlet 52a of the air introduction passage 52A extends in the horizontal direction. The upper end of the inlet 52a is located at the same height as the lower end of the vane plate 54. On the other hand, the lower end 52b1 of the outlet 52b of the air introduction passage 52A is located at a position slightly higher than the upper end of the inlet 52a. Therefore, the upper end of the inlet 52a of the air introduction passage 52A of the present embodiment is located below the lower end 52b1 of the outlet 52b of the air introduction passage 52A.

In the flow guide portion 48B, a plurality of air introduction passages 52A are arranged at regular intervals in the up-down direction. The air introduction passages 52A are arranged parallel to each other.

The ventilation device 32A of the present embodiment has the same effect as the ventilation device 32 described with reference to FIGS. 2 to 5.

Although preferred embodiments of the present invention have been described above, the present invention is not limited to the above-described embodiments, and various modifications can be made without departing from the spirit of the present invention.

What is claimed is:

1. A fuel cell system comprising: a fuel cell stack in which a plurality of power generating cells are stacked;
a stack case that houses the fuel cell stack;
a ventilation device that is provided for the stack case and takes outside air into the stack case; and
a flow guide portion that is provided for the ventilation device and has a plurality of slit-shaped air introduction passages that are inclined upward from an outer side of the stack case toward an inner side of the stack case and are arranged in parallel with each other,
wherein an upper end of an inlet of each of the air introduction passages is located below a lower end of an outlet of each of the air introduction passages.

2. The fuel cell system according to claim 1, wherein the flow guide portion includes a plurality of air introduction passages having the same width in a horizontal direction and is formed in a rectangular shape when viewed from front.

3. The fuel cell system according to claim 1, wherein the stack case is mounted in a vehicle and the ventilation device is provided in the front of the vehicle in which the stack case is mounted.

4. The fuel cell system according to claim 3, wherein the ventilation device is disposed so as to face a side portion with respect to a stacking direction of the power generating cells.

5. The fuel cell system according to claim 3, wherein the ventilation device includes a first flow guide portion provided on a lower portion of a front surface of the stack case and a second flow guide portion provided on an upper portion of the front surface of the stack case.

6. The fuel cell system according to claim 5, wherein the second flow guide portion is formed in a range extending over an entire area in the stacking direction of the fuel cell stack.

7. The fuel cell system according to claim 1, wherein the ventilation device includes: a frame portion that contacts and is fixed to a surface of the stack case; and a concave portion that is concave further inward than a surface of the frame portion, and the flow guide portion is provided in the concave portion.

8. The fuel cell system according to claim 1, wherein the air introduction passages are convex upward.

9. A method for ventilating a fuel cell system mounted in a vehicle, comprising: a fuel cell stack in which a plurality of power generating cells are stacked; a stack case that houses the fuel cell stack; and a ventilation device provided for the stack case and taking outside air into the stack case,
wherein the ventilation device includes a flow guide portion in which a plurality of slit-shaped air introduction passages are inclined upward from an outer side of the stack case toward an inner side of the stack case and are arranged in parallel with each other,
the ventilation device is disposed toward a front of the vehicle, whereby an upward air flow is generated inside the stack case by utilizing wind pressure of running wind generated by driving of the vehicle, and diffusion of hydrogen gas staying in an upper portion of the stack case is enhanced.

10. The method according to claim 9, wherein the ventilation device is disposed on a side portion with respect to a stacking direction of the power generating cells, whereby an air flow caused by the running wind of the vehicle is applied to the plurality of power generating cells.
